(19) United States
(12) Patent Application Publication
(10) Pub. No.: US 2008/0197776 A1
(43) Pub. Date: Aug. 21, 2008

(54) HOT-CATHODE FLUORESCENT LAMP

(75) Inventor: Hitoshi NOZAKI, Tokyo (JP)

Correspondence Address: YOUNG & THOMPSON, 209 Madison Street, Suite 500, ALEXANDRIA, VA, 22314, US

(73) Assignee: NEC LIGHTING, LTD., TOKYO (JP)

(21) Appl. No.: 12/025,064

(22) Filed: Feb. 4, 2008

(30) Foreign Application Priority Data
Feb. 21, 2007 (JP) 2007-040747

(51) Int. Cl. H01J 17/06

(52) U.S. Cl. 313/629

(57) ABSTRACT

A hot-cathode fluorescent lamp has an arc tube on whose inside surface a phosphor film is formed, and in both ends of which stems are formed, and has bases having tube pins connected to an external power supply and fixed to both end portions of the above-mentioned arc tube. The hot-cathode fluorescent lamp is equipped with pairs of metal lead wires which are provided in both ends of the arc tube, one ends of which are connected to tube pins, and the other ends of which are extended inside the arc tube through the stem, a filament both ends of which are connected to the other ends of respective lead wires, and a screening member which has a ring portion surrounding the filament and which has a bottom face plate provided in a side of the ring portion which side opposites to the stem so as to screen the stem from the filament.

This application is based upon and claims the benefit of priority from Japanese Patent Application No. 2007-040747 filed on Feb. 21, 2007, the content of which is incorporated by reference.

### BACKGROUND OF THE INVENTION

1. Field of the Invention

The present invention relates to a hot-cathode fluorescent lamp.

2. Description of the Related Art

FIG. 1 is a sectional view of a hot-cathode fluorescent lamp according to the claimed invention.

Hot-cathode fluorescent lamp 1 has arc tube 11 and bases 21. Stems 12 which comprise glass members for fixing filament 31 are formed in both ends of arc tube 11. Phosphor film 13 is formed on an inside surface of arc tube 11. Each of bases 21 has a pair of tube pins 22 connected to an external power supply, and which is being fixed to an end portion of arc tube 11. Each pair of metal lead wires 32 one ends of which are connected to tube pins 22, and the other ends of which is extended inside arc tube 11 through stem 12, and filament 31 both ends of which are connected to the other ends of respective lead wires 32, are provided in an interior of both ends of the arc tube 11. Each electrode portion 30 is formed of these lead wires 32 and filament 31.

Electron radioactive substances (emitters) such as BaO, CaO, and SrO are coated on a surface of each filament 31. Several mg of mercury and a rare gas, a main component of which is argon, with several Torr of pressure, are sealed inside arc tube 11.

When filament 31 is energized before starting a hot-cathode fluorescent lamp 1, thermoelectrons are emitted from the emissive materials (emitters) on the heated surface of filament 31. After that, when a high voltage is applied between filaments 31 in both ends of arc tube 11, an electric field is induced, the thermoelectrons are attracted to an anode, and discharge is started. The accelerated electrons collide with a rare gas or vapor of mercury which is enclosed in arc tube 11, and then, ultraviolet rays are emitted. Then, ultraviolet rays excite phosphor of phosphor film 13 of arc tube 11, and visible light is generated. In this case, there are the following problems.

(1) Scattering substances emitted from the emitters, filament 31, and the like adhere to phosphor film 13 near filament 31, and cause a portion where the scattering substances adhere to turn black and lower luminous efficiency. In consequence, uneven brightness occurs in arc tube 11. In particular, when arc tube 11 is used for back lighting in an image display apparatus etc., it is necessary that uniform brightness be obtained in the range of the determined length of arc tube 11. Therefore, when using arc tube 11 for back lighting, scattering substances that adhere near the filament 31 cause a disadvantage.

(2) In hot-cathode fluorescent lamp 1 which has filament 31, if a certain distance is not provided between filament 31 and stem 12, stem 12 is heated and base 21 etc. may be heated excessively. Therefore, it is necessary to keep a distance between filament 31 and stem 12 to some extent.

(3) When the emitters coated on filament 31 have been exhausted at the time when the lamp is lit or during the period in which the lamp is lit, and when the emitters are drained, it becomes difficult for hot-cathode fluorescent lamp 1, which uses a hot cathode system, to discharge, and hot-cathode fluorescent lamp 1 reaches the end of its service life. The lamp which reached the end of its service life completes discharging as it is, and it is preferred that it never be turned on again. Nevertheless, there are rare circumstances in which the lamp is discharged beyond its service life and this may adversely affect the lamp apparatus or the apparatus in which the lamp is embedded. The following two points are cited as its cause.

A first cause is as follows. Usually, when the emitters remain, energy (cathode drop voltage) necessary to emit electrons is about 10 V. However, when the lamp is repeatedly discharged and the emitters that are coated on filament 31 are drained, only tungsten which is a main material of filament 31 remains, and the cathode drop voltage rises from tens of V to 100 V. Thus, the amount of the electric power which is about 10 times the usual amount of the electric power will be supplied to filaments 31. Thereby, filaments 31 are overheated and the temperature of near-by stems 12 become excessively high, and lead wires 32 around them, bases 21, and the like may melt.

A second cause is as follows. In particular, when starting to light hot-cathode fluorescent lamp 1 and when the lamp current is changing, the amount of scattering of emitters increases. The scattering emitter substances also adhere to an inside wall of arc tube 11 near filament 31 and to glass stems 12 that support filament 31. By repeatedly lighting up the lamp, these scattering substances are deposited gradually. Even when a filament becomes nonconductive, scattering substances deposited on stem 12 reach a conducting state, a portion where scattering substances are deposited is overheated, and lead wire 32 and base 21 may be abnormally heated.

The temperature of electrode portion 30 in which the emitters are drained rises to a temperature higher than that at the time of usual lighting, and much electric power is consumed in the electrode in which the emitters are drained, based on the increase of the cathode drop voltage. This feature is common at the time of overheating.

(4) Depending on the state of ambient temperature when a hot cathode fluorescent lamp is used in a closed space, etc., the temperature of the interior of arc tube 11 may become too high, mercury vapor pressure may become high, and the mercury vapor pressure may deviate from the optimum value of luminous efficiency. Then, it is conceivable to amalgamate mercury at the coldest point of the lamp, where the cooling rate is fast at the time when the lamp is turned off, and to make the pressure in the arc tube into predetermined mercury vapor pressure. However, in that case, since time is needed for the amalgam temperature to rise, depending on the position of the coldest point, a problem may arise when starting to light up the lamp.

(5) As regards the luminous efficiency, the hot-cathode fluorescent lamp is superior to a cold-cathode fluorescent lamp, which is mainly used in the back lighting for image display. However, the service lifetime of the current hot-cathode fluorescent lamp is 6000 to 10000 hours, which is short for using it as a back light. If the service lifetime of a hot-cathode fluorescent lamp can be extended, it can also satisfy the requirement for use as a back lighting source, and can become environmentally friendly by decreasing waste.

By solving the above problems, the service lifetime of a hot-cathode fluorescent lamp can also be lengthened, and abnormal heating of a lamp base which arises at the end of life of the lamp can be suppressed. Therefore, it becomes possible to use a hot-cathode fluorescent lamp in a closed space, and further, it becomes possible to incorporate a hot-cathode fluorescent lamp into a display unit etc. In addition, since the entire length of electrode portion 30 can be short, a positive column can be lengthened and luminous efficiency is improved.

As a measure to prevent a scattering substance from depositing on the inside wall of stem 12 and arc tube 11, one proposal calls for providing an obstruction that will block the scattering substance around filament 31. In Japanese Patent Application Laid-Open No. 2004-158207, a method of providing a shield between lead wires to block a scattering object from a filament from accumulating on a stem is disclosed. In Japanese Patent Laid-Open No. 2005-235749, a method of arranging a coil portion of a filament in a longitudinal direction and providing a sleeve covering around the coil portion to suppress ion sputtering is disclosed.

In Japanese Patent Application Laid-Open No. 2005-346976, a fluorescent lamp which has metal plates supported by stems for screening the stems from filaments, and getters which are provided on the metal plates and which emit an impurity gas when temperature of the filaments rises with abnormal lighting at the time of an end of life of a lamp is disclosed.

In addition, in order to suppress a scattering substance, emitted from a filament, from adhering to the stems, one approach that is being used is to arrange a ceramic plate between each filament and each stem.

Since the hot-cathode fluorescent lamp shown in FIG. 1 has these above-described problems, a hot-cathode fluorescent lamp which has the following features is required.

(1) The capability to suppress substances, which comprise an emitter and a filament, from scattering and adhering to the inside surface of an arc tube at the time when the lamp is started up and during the time when the lamp is lit.

(2) The capability to suppress substances, which comprise an emitter and a filament, from scattering and adhering to the surface of a stem at the time when the lamp is started up and during the time when the lamp is lit.

(3) The capability to shorten the distance between a sealing portion and a filament (thereby, the capability to lengthen the length of a positive column).

(4) The capability to suppress abnormal heating of the stem from occurring at the end of lifetime of the lamp.

(5) The coldest point structure be incorporated into the fluorescent lamp, this structure can amalgamate mercury efficiently at the time that the lamp is turned off, and can gasify the mercury promptly, inside the lamp, when the lamp is started up.

(6) A getter which plays the role of absorbing an impurity gas in the tube is provided.

### SUMMARY OF THE INVENTION

An exemplary object of the invention is to provide a hot-cathode fluorescent lamp which has the above mentioned capabilities.

According to an exemplary aspect of the invention, a hot-cathode fluorescent lamp has an arc tube on whose inside surface a phosphor film is formed, and in both ends of which stems are formed, and which has bases having tube pins connected to an external power supply and fixed to both end portions of the above-mentioned arc tube. The above-mentioned hot-cathode fluorescent lamp is equipped with pairs of metal lead wires which are provided in both ends of the arc tube, one ends of which are connected to the tube pins, and the other ends of which are extended inside the arc tube through the stems, a filament both ends of which are connected to the other ends of the respective lead wires, and a screening member which comprises a ring portion surrounding the filament and which comprises a bottom face plate provided in a side of the ring portion which side opposites to the stem so as to screen the stem from the filament.

The above and other objects, features and advantages of the present invention will become apparent from the following description with reference to the accompanying drawings which illustrate examples of the present invention.

### BRIEF DESCRIPTION OF THE DRAWINGS

FIG. 1 is a sectional view of a hot-cathode fluorescent lamp related to the claimed invention;

FIG. 2A is a sectional view showing the vicinity of an electrode portion of the hot-cathode fluorescent lamp according to an exemplary embodiment; and

FIG. 2B is a plan view of a screening member shown in FIG. 2A.

### DESCRIPTION OF THE EXEMPLARY EMBODIMENTS

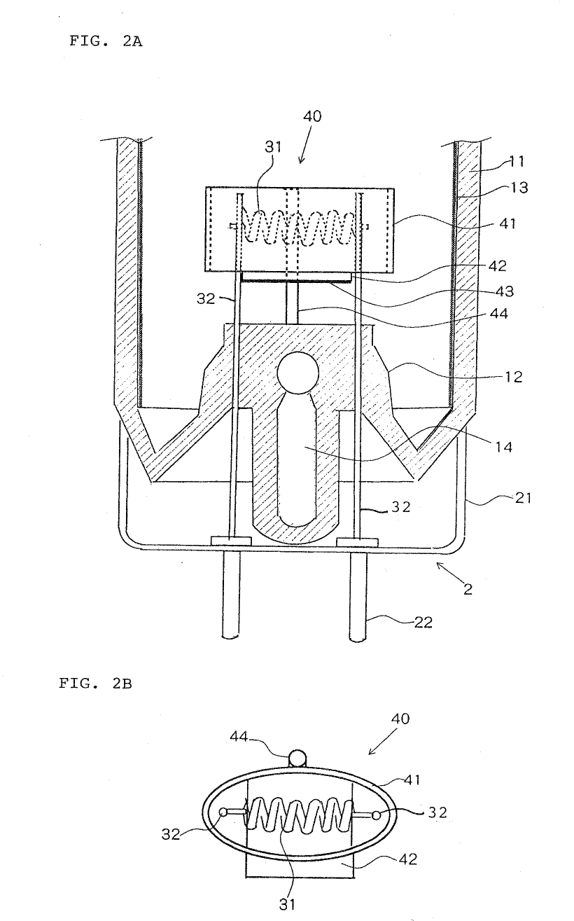

FIG. 2A is a sectional view showing the vicinity of an electrode portion of a hot-cathode fluorescent lamp according to an exemplary embodiment. FIG. 2B is a plan view of a screening member shown in FIG. 2A.

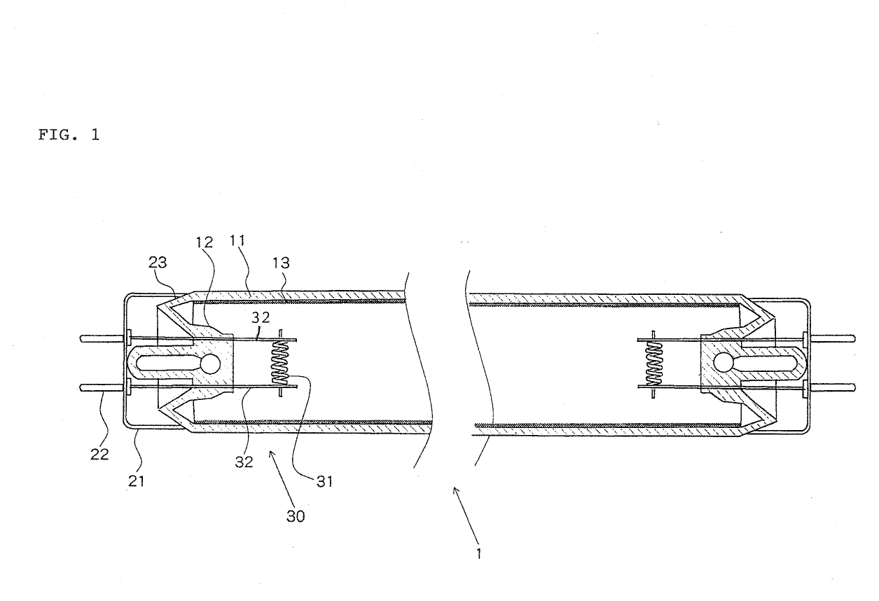

The fundamental structure and functions of hot-cathode fluorescent lamp 2 of the exemplary embodiment are common to those of hot-cathode fluorescent lamp 1 described with reference to FIG. 1, and except for screening member 40 that is provided in electrode portion 30, they are the same as in the construction in FIG. 2. Hence, since hot-cathode fluorescent lamp 1, shown in FIG. 1 and hot-cathode fluorescent lamp 2 of the exemplary embodiment have a common construction, the same reference numerals will be assigned and their descriptions will be omitted. Hereinafter, the construction and functions of screening member 40 will be mainly described.

In hot-cathode fluorescent lamp 2, screening members 40 each of which surrounds filament 31 of electrode portion 30 are provided. Each of screening members 40 has ring portion 41, bottom face plate 42, getter 43, and holding support 44. Ring portion 41 is annular, but elliptical in the shown example.

Ring portion 41 has a shape that allows it to surround filament 31 of electrode portion 30 as closely as possible, and ring 41 is held in a state in which holding support 44 separates ring portion 41 from stem 12 lest ring portion 41 make contact with filament 31 and lead wire 32 that supports the filament. Thus, it is possible to prevent, at a minimum, a substance which comprises the emitter and filament 31 from scattering in a radial direction of arc tube 11 during lighting, and from adhering to phosphor film 13 on the inside surface of arc tube 11.

Bottom face plate 42 is extended from the bottom face of one long side of elliptical ring portion 41 toward another long side. Getter 43 is provided in the lower side face of bottom face plate 42.

Bottom face plate 42 is arranged at the side of filament 31 which side opposites to stem 12 and is arranged adjacent to filament 31. Thereby, heat radiated from filament 31, which is emitted to a glass part of stem 12, is suppressed, and it is possible to minimize the distance, which is necessary to protect a glass surface from the radiated heat, from filament 31 to the top surface of stem 12, and hence it is possible to lengthen the positive column in the lamp by the minimized distance. Since the positive column becomes long, it is possible to further raise luminous efficiency.

In addition, the scattering of substances, which comprise the emitter and filament 31, toward stem 12 during lighting is prevented, and deposition of the scattering substances on the glass surface of stem 12 is reduced. Hence, it is possible to prevent abnormal heating of the stem portion at the end of life of the lamp by a short circuit caused by the scattering substances.

Furthermore, it is possible to promote absorption of an impurity gas in arc tube 11 by getter 43 that is arranged under bottom face plate 42.

Ring portion 41, bottom face plate 42, and holding support 44 are made of heat resistant materials, such as metal, ceramic, or glass. Furthermore, it is preferable that these members are made of material whose heat dissipation is higher than that of the other components of fluorescent lamp 2. Thereby, it is possible to make these members become the coldest point of the fluorescent lamp when the lamp is turned off from a lighted state, and these members can play the role of an auxiliary amalgam which amalgamates mercury vapor.

While the invention has been particularly shown and described with reference to exemplary embodiments and examples thereof, the invention is not limited to these embodiments and examples. It will be understood by those of ordinary skill in the art that various changes in form and details may be made therein without departing from the spirit and scope of the present invention as defined by the claims.

What is claimed is:

1. A hot-cathode fluorescent lamp, comprising:
an arc tube on whose inside surface a phosphor film is formed, and in both ends of which stems are formed;
bases each comprising a tube pin connected to an external power supply, and being fixed to an end portion of the arc tube;
pairs of metal lead wires which are provided in both ends of the arc tube, one ends of which are connected to the tube pins, and the other ends of which are extended inside the arc tube through the stems;
a filament both ends of which are connected to the other ends of the respective lead wires; and
a screening member which comprises a ring portion surrounding the filament and which comprises a bottom face plate provided in a side of the ring portion which side opposites to the stem so as to screen the stem from the filament.

2. The hot-cathode fluorescent lamp according to claim 1, wherein said screening member is held in a state of being separated from said stem.

3. The hot-cathode fluorescent lamp according to claim 1, wherein a getter which absorbs an impurity gas is provided on a face of said bottom face plate which face opposites to the stem.

4. The hot-cathode fluorescent lamp according to claim 1, wherein said screening member is comprised of a material whose heat dissipation is higher than a material which comprises other components in the hot-cathode fluorescent lamp.
